(19) United States
(12) Patent Application Publication
(10) Pub. No.: US 2018/0241752 A1
(43) Pub. Date: Aug. 23, 2018

(54) METHOD AND DEVICE FOR DYNAMICALLY UPDATING FUNCTIONALITY OF A DEVICE

(71) Applicant: Lenovo (Singapore) Pte. Ltd., New Tech Park (SG)

(72) Inventor: Jonathan Gaither Knox, Morrisville, NC (US)

(21) Appl. No.: 15/440,579

(22) Filed: Feb. 23, 2017

(51) Int. Cl. H04L 29/06

(52) U.S. Cl. CPC H04L 63/10; G06F 2221/2149; H04L 63/0876

(57) ABSTRACT

A computer implemented method, device, and system are provided that are under the control of one or more processors having instructions. The method, device, and system receive control attributes related to functionality of a base device from a user interface. The method, device, and system further detect tokens from one or more secondary devices. The method, device, and system dynamically update the functionality of the base device in association with the tokens.

### BACKGROUND

Embodiments herein generally relate to methods and devices for dynamically updating the functionality of a device based on secondary device tokens.

Today, electronic devices have become essential to everyday life in many ways. Access to electronic devices can benefit people in various ways, such as providing better communication, information for work and school, and entertainment. However, access to electronic devices can also negatively impact health and safety, in particular for children. In this day and age, most children have access to a glut of electronic devices at almost any time and any place, including school, home, public places, and the homes of friends and family. In many cases, children now carry mobile electronic devices with them at all times. Increasingly, experts report the negative health impact to children from overuse or use during inappropriate times of electronic devices. If not properly monitored, electronic devices can also expose children to inappropriate content and potentially dangerous persons.

Monitoring and controlling the content and the amount of time spent on electronic devices has become an enormous challenge for parents. There are several conventional methods and devices available to parents that provide parental controls for electronic devices. Typically, parental controls allow parents to block specific content deemed inappropriate. For example, parental control software may include a list of content sources identified by the parent, or use heuristics to identify content that is inappropriate. However, these methods may be difficult and time-consuming for parents to manage and update on a continuous basis. In addition, the use of heuristics can result in many false negatives and false positives. In another example, parental controls allow parents to block access based on predetermined criteria, such as ratings, time of day, applications, or channels. Often, parents set up these controls during the initial setup of the electronic device based on criteria that apply at that moment in time. However, as time passes the chosen criteria may become outdated due to changes in users, age, routine, or other factors. As a result, the parental controls become less effective and less efficient over time.

Overall, conventional methods are inefficient, ineffective, and too limiting in parental control mechanisms. A need remains for methods and devices that afford more dynamic parental controls that overcome the foregoing and other disadvantages of conventional parental control management approaches.

### SUMMARY

In accordance with embodiments herein, an electronic device is provided comprising a processor and a data storage device having executable instructions accessible by the processor. Responsive to execution of the instructions, the processor receives control attributes related to functionality of a base device, detects tokens from one or more secondary devices and dynamically updates the functionality of the base device in association with a current one of the tokens.

Optionally, the electronic device is an auxiliary device. The auxiliary device may communicate with the secondary devices to detect the tokens. The auxiliary device may communicate with the base device to direct the base device to dynamically update the control attributes. Optionally, the electronic device is the base device. The processor may authorize a supervising user to input the control attribute in association with a supervised user of the base device. The processor may monitor and manage the base device according to the control attributes.

Optionally, the processor may poll the secondary devices for the tokens. The processor may determine a binary signal of the token. The processor may determine an association between the tokens and the control attributes.

In accordance with embodiments herein, a non-signal readable data storage device comprising executable code to receive control attributes related to a base device detect a token from one or more secondary devices utilizing the base device and dynamically update the control attributes on the base device in association with the tokens.

Optionally, the base device may house the processor and the data storage device. The base device may communicate with the secondary devices to detect the token. The non-signal readable data storage device may further comprise executable code to monitor and manage the secondary device according to the control attributes. The non-signal readable data storage device may comprise executable code to monitor and manage the base device according to the control attributes. The non-signal readable data storage device may comprise executable code to determine a binary signal of the token and determine an association between the tokens and the control attributes. The non-signal readable data storage device may further comprise executable code to authorize a supervising user.

In accordance with embodiments herein, a method is provided. The method is under control of one or more processors, receives control attributes related to functionality of a base device, detects tokens from one or more secondary devices, and dynamically updates the functionality of the base device in association with the tokens.

Optionally, the method may poll the one or more secondary devices for the tokens. The method may authorize a supervising user to input the control attribute in association with a supervised user. The method may utilize an auxiliary device for communicating with the secondary devices to detect the tokens and for communicating with the base device to dynamically update the control attributes. The method may monitor and manage the base device according to the control attributes. The method may further comprise determining an association between the tokens and at least one of the control attributes.

### BRIEF DESCRIPTION OF THE DRAWINGS

FIG. 1 illustrates a system for dynamically updating the functionality of a base device in accordance with embodiments herein.

FIG. 2 illustrates a simplified block diagram of a device in accordance with embodiments herein.

FIG. 3 illustrates a process for dynamically updating the functionality of a base device in accordance with embodiments herein.

FIG. 4 illustrates a chart of tokens related to secondary devices in accordance with the embodiments herein.

FIG. 5 illustrates a simplified block diagram of a device in accordance with embodiments herein.

FIG. 6 illustrates a process for dynamically updating the functionality of a base device in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The terms “communications content” and “content” as used throughout shall generally refer to any and all textual, audio or video information or data conveyed to or from a device during a communications event. The content may represent various types of incoming and outgoing textual, audio, graphic and video content including, but not limited to, calendar updates, email, text messages, voicemail, incoming phone calls, as well as other content in connection with social media and the like.

The terms “dynamically update” as used throughout shall generally refer to the active incorporating, refreshing, altering, changing, and/or revising of information, content, or data in relation to a change in time, condition, parameter, criteria or attribute. The term “dynamically update” can be also characterized by occurring at the time needed rather than in advance. A dynamic update does not require nor preclude the need for storage or caching information and/or data.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

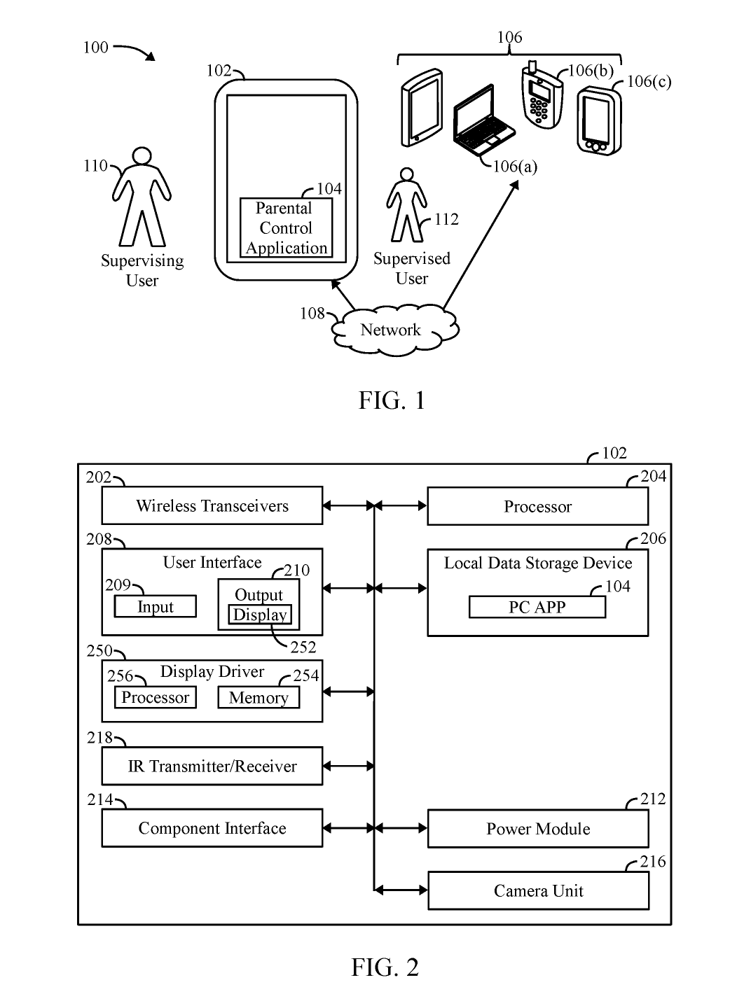

FIG. 1 provides an illustration of a system 100 to implement and/or dynamically update the functionality of a base device in accordance with embodiments herein. The system 100 includes a base device 102 with a parental control (PC) application 104, one or more secondary devices 106, and a network 108 operatively connected to the base device 102 and to the secondary devices 106. FIG. 1 depicts the base device 102 as a tablet and the secondary devices 106 as a laptop computer 106a, a fitness tracking device 106b, and a mobile telephone 106c. However, non-limiting examples of the base device 102 and secondary devices 106 also include tablet computers, personal digital assistants, desktop computers, cameras, televisions, video and audio players, gaming systems, vehicle information and communication systems, and the like.

According to control attributes defined by the PC application 104, the base device 102 can be operated by supervising users 110, such as parents, medical professionals, employers, teachers, coaches, landlords or other authorized individuals. The base device 102 can also be operated by supervised users 112, such as children, adolescents, patients, employees, students, tenants and other unauthorized individuals who warrant supervision. The supervising users 110 have interpersonal relationships with the supervised users 112 for the purpose of overseeing, monitoring, directing, managing, or assuming responsibility of the interaction of the supervised users 112 with the base device 102, secondary devices 106, and/or the auxiliary device 502. For example, parents have an interpersonal relationship with children for the purpose of parenting. Accordingly, parents may monitor and manage the children's interaction with the devices with the objective of benefiting the children's safety and discipline. In another example, teachers have interpersonal relationships with students through their association at school for the purpose of education. Accordingly, teachers may monitor and manage the student's interaction with the devices with the objective of benefiting the student's safety and education. Medical professionals have interpersonal relationships with patients through their association at medical facilities for the purpose of health services. Accordingly, medical professionals may monitor and manage the patient's interaction with the devices with the objective of benefiting the patient's safety and health. Employers have interpersonal relationships with employees through their association at workplaces for the purpose of employment. Accordingly, employers may monitor and manage the employee's interaction with the devices with the objective of benefiting the employee's productivity and morale.

Conversely, supervising users 110 and supervised users 112 do not include persons that have no interpersonal relationship with each other. For example, a software licensee and an end-user do not have an interpersonal relationship, but rather interact merely for the purpose of a executing a commercial transaction.

Supervising users 110 are authorized to administer the PC application 104 to control operation of the base device 102 for both supervising users 110 and supervised users 112 according to the control attributes as determined by the supervising user 110. Supervised users 112 are not authorized to administer the PC application 104, but are can operate the base device 102 according to the control attributes established in the PC application 104 by the supervising users 110.

In the embodiment of FIG. 1, the base device 102 is a tablet which can include various downloadable applications, online services, video and audio media, games, a camera, and a variety of other content. Parents generally do not want their children to have unlimited access to use the base device 102. As another example, office managers do not want employees to spend unlimited amounts of time accessing network-based content for leisure reasons. Accordingly, the PC application 104 administers the access, content, and function of the base device 102 according to control attributes. The control attributes and/or functionality of the base device can be determined and dynamically updated by changes in one or more tokens communicated by the secondary devices 106 to the base device 102.

The control attributes can be binary based, providing for two states of operation, such as an on/off switch. For example, the PC application 104 can dynamically update the functionality by prohibiting operation of the base device 102 or an individual component or application as indicated by a token from one or more of the secondary devices 106. Alternatively, the control attributes can be non-binary based, providing for multiple states of operation. For instance, the PC application 104 can dynamically update the functionality by managing an internet browser to provide varying degrees of access to content.

Each secondary device 106 can communicate tokens to the base device 102. By way of example, a token may represent a binary signal indicating correspondingly whether a condition exists or an event is occurring. The PC application 104 uses the tokens to manage and update the functionality and/or control attributes related to the base device 102. For example, supervising users 110 can designate the control attributes so that the base device 102 is operational, such as a binary on or off status, when the secondary device 106 is located within a predetermined range. More specifically, the mobile device 106c can include a GPS or proximity sensor that indicates its position relative to the base device 102. If the mobile device 106c is located within a predetermined range of the base device 102, the mobile device 106c may transmit a token indicating an “ON” signal and, in accordance with the control attributes, the PC application 104 enables one or more settings of the base device 102 to be operational for the supervised users 112. If the mobile device 106c is outside of the predetermined range, the token indicates an “OFF” signal and, in accordance with the control attributes, the PC application 104 disables one or more operational settings of the base device 102 to be inoperable for the supervised users 112.

In another example, the fitness tracking device 106b can include a mechanism to determine if the user is awake or asleep. If the fitness tracking device 106b determines that the user is awake, the token indicates an “ON” signal and, in accordance with the control attributes, the PC application 104 enables the base device 102 to be operational for the supervised users 112. If the fitness tracking device 106b determines that the user is asleep, the token indicates an “OFF” signal and, in accordance with the control attributes, the PC application 104 renders the base device 102 inoperable for the supervised users 112.

In another example, the laptop computer 106a can send a signal via the network 108 to indicate that the user has completed an activity, such as completion of a homework assignment. For example, the homework assignment may be transmitted to a teacher by any suitable form of electronic communication, including but not limited to, email, a software program, an online website, and the like. Transmission may be indicated by transmitting a signal to the laptop computer 106a. Alternatively, the laptop computer 106a may include a software program that tracks progress and completion of the homework assignment. The supervised user 112 utilizes the software program to indicate progress on a homework assignment. When a homework assignment is completed or a predetermined amount of progress is achieved, the software program transmits a signal to the laptop computer 106a. If the laptop computer 106a determines that the homework assignment has been completed or transmitted, such as by receiving a signal, the token indicates an “ON” signal and, in accordance with the control attributes, the PC application 104 renders the base device 102 operational for the supervised users 112. If the laptop computer 106a determines that the homework assignment is not completed, the token indicates an “OFF” signal and, in accordance with the control attributes, the PC application 104 renders the base device 102 inoperable for the supervised users 112.

Accordingly, the base device 102 can monitor a plurality of tokens from a plurality of secondary devices 106 respective to the control attributes. In this way, the PC application 104 can manage the access, content, and function of the base device 102 according to control attributes.

FIG. 2 illustrates a simplified block diagram of the base device 102 of FIG. 1 in accordance with an embodiment. The base device 102 includes a housing with components such as one or more wireless transceivers 202, one or more processors 204 (e.g., a microprocessor, microcomputer, application-specific integrated circuit, etc.), one or more local data storage devices 206 (also referred to as a memory portion), a user interface 208 which includes one or more input devices 209 and one or more output devices 210, a power module 212, a component interface 214, a camera unit 216, and a display driver 250. All of these components can be operatively coupled to one another and can be in communication with one another by way of one or more internal communication links, such as an internal bus.

The user interface 208 permits the user to operate the base device 102 for any of its intended purposes, such as administering the PC application 104, operating software applications, electronic communication, capturing images with the camera unit 216, listening to audio media, viewing video media, and the like. To that end, the input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen 252, one or more light emitting diode indicators, an audio output device such as a speaker, alarm and/or buzzer, and a mechanical output device such as a vibrating mechanism. The display 252 may be touch sensitive to various types of touch and gestures. As further examples, the output device 210 may include a touch sensitive screen, a non-touch sensitive screen, a text-only display, a smart phone display, an audio output (e.g., a speaker or headphone jack), and/or any combination thereof.

The display driver 250 is coupled to the processor 204 and configured to manage display of content on the display 252. The display driver 250 is connected to primary and secondary viewing regions of the display 252. The display driver 250 writes the desired content to the primary and secondary viewing regions under direction of the main processor 204. Optionally, the display driver 250 includes display memory 254 and one or more display control processors 256. The display memory 254 includes multiple sections to which the display control processors 256 and/or processor 204 write content to be displayed. The sections of the display memory 254 are mapped to corresponding regions of a flexible display layer. The display driver 250 provides a common display interface for all of the viewing regions within the flexible display layer within the display 252. For example, the display driver 250 manages display of content in the primary and secondary viewing regions.

The user interface 208 permits the user to select one or more of a switch, button or icon to collect target designation data, and/or enter indicators to direct the camera unit 216 to take a photo or video (e.g., capture image data). As another example, the user may select a content collection button on the user interface 208 two or more successive times, thereby instructing the base device 102 to capture the image data.

As another example, the user may enter one or more predefined touch gestures and/or voice commands through a microphone on the base device 102. The predefined touch gestures and/or voice commands may instruct the base device 102 to collect image data for a scene and/or a select object in the scene.

The local data storage device 206 can encompass one or more memory devices of any of a variety of forms (e.g., read only memory, random access memory, static random access memory, dynamic random access memory, etc.) and can be used by the processor 204 to store and retrieve data. The data that is stored by the local data storage device 206 can include, but need not be limited to, operating systems, applications, user collected content, and informational data. Each operating system includes executable code that controls basic functions of the device, such as interaction among the various components, communication with external devices via the wireless transceivers 202 and/or the component interface 214, and storage and retrieval of applications and data to and from the local data storage device 206. Each application includes executable code that utilizes an operating system to provide more specific functionality for the communication devices, such as file system service and handling of protected and unprotected data stored in the local data storage device 206.

The local data storage device 206 stores various content including, but not limited to, the PC application 104 and control attributes. The PC application 104 manages one or more operations of the base device 102. The PC application 104 includes instructions accessible by the one or more processors 204 to direct the processor 204 to implement the methods, processes and operations described herein including, but not limited to, the methods, processes and operations illustrated in the Figures and described in connection with the Figures.

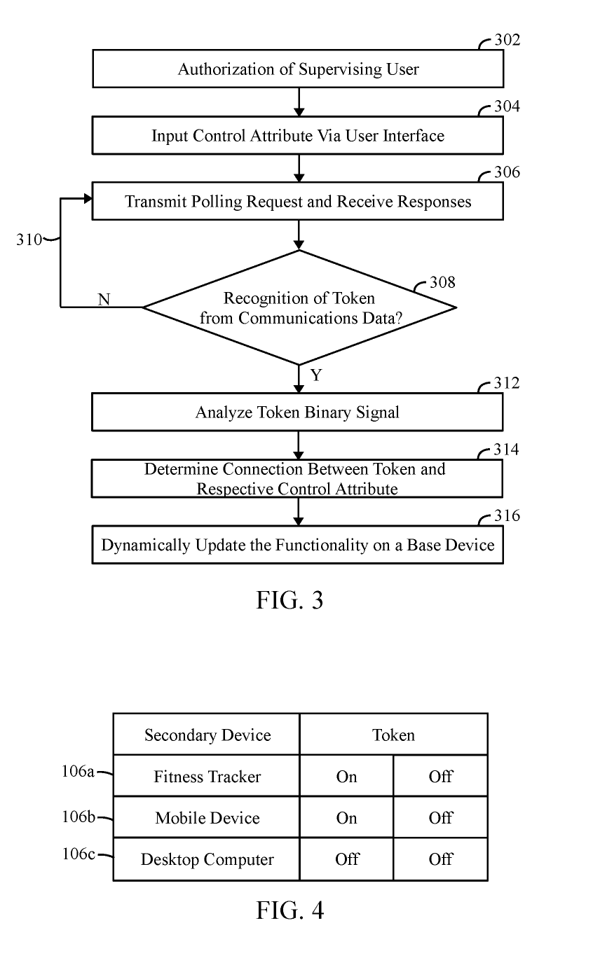

Among other things, the PC application 104 manages operation of the processor 204 in association with monitoring communication signals from the secondary devices 106. In accordance with the embodiment of FIG. 3, the processor 204 directs the transceiver 202 to transmit an inquiry request, or poll, and listen for responses from secondary devices 106. The processor 204 analyzes the communication signals from the secondary devices 106 to identify tokens. The PC application 104 directs the processor 204 to utilize the tokens to determine, set, and/or adjust one or more of the control attributes. For example, the processor 204 may prohibit or provide access to software applications, the camera unit 216, or other input and output devices 209, 210 in association with the tokens. Alternatively, the processor 204 may control the scope of content available in specific software applications in association with the tokens. For instance, the processor 204 may limit an audio or video software application to only play content from a designated list of content sources or content that meets approved ratings. In another example, the processor 204 may control the scope of electronic communications in association with the tokens. For instance, the processor 204 may limit communications, such as email, social media applications, text, or instant messaging, to a designated list of contacts, designated times of day, or a designated amount of time per day.

Other applications stored in the local data storage device 206 include various application program interfaces (APIs), some of which provide links to/from a cloud hosting service. The power module 212 preferably includes a power supply, such as a battery, for providing power to the other components while enabling the base device 102 to be portable, as well as circuitry for the battery to be recharged. The component interface 214 provides a direct connection to other devices, auxiliary components, or accessories for additional or enhanced functionality, and in particular, can include a USB port for linking to a user device with a USB cable.

Each transceiver 202 can utilize a known wireless technology for communication. Exemplary operation of the wireless transceivers 202, in conjunction with other components of the base device 102, may take a variety of forms. For example, the wireless transceivers 202 may operate in a way which, upon reception of wireless signals, the components of the base device 102 may detect communication signals from the secondary devices 106 and the transceiver 202 may demodulate the communication signals to recover incoming information such as token data, responses to inquiry requests, or voice and/or data transmitted by the wireless signals. The processor 204 formats outgoing information and conveys the outgoing information to one or more of the wireless transceivers 202 for modulation to communication signals. The wireless transceivers 202 convey the modulated signals to a remote device, such as a cell tower or a remote server (not shown). Optionally, the base device 102 may have an IR transmitter 218 to be used in association with communicating with other electronic secondary devices that are responsive to incoming IR communications directions.

FIG. 3 illustrates a process for dynamically updating multiple control attributes, in accordance with embodiments herein. The operations of FIG. 3 are carried out by the one or more processors 204 of the base device 102 in response to execution of instructions such as in the PC application 104 and/or other applications stored in the local data storage device 206.

At 302, the PC application 104 authorizes that the operator is a supervising user 110 with any suitable method, such as inputting a password, biometric data, or other identifying information. At 304, the supervising user 110 inputs the desired control attributes via the user interface 208, which are stored in the local data storage device 206.

At 306, the base device 102 transmits a polling request over one or more wired or wireless medium in association with the secondary devices 106 and receives responses from the one or more secondary devices 106. The content and nature of the polling requests and responses may vary based upon various factors. For example, the requests and responses may be conveyed in accordance with a Bluetooth protocol. Optionally, the requests and responses may be conveyed in accordance with various wireless protocols, such as 802.11, wireless local area network (WLAN), Wi-Fi protected access (WPA), wired equivalent privacy (WEP), Wi-Fi, wireless broadband and the like. As other examples, the request and responses may be conveyed in accordance with various communications protocols, such as a hypertext transfer protocol (HTTP), Internet relay chat (IRC) and the like. Optionally, the communications data may be captured utilizing infrared, such as when the secondary device includes an IR transmitter. The base device 102 may include an IR receiver that receives IR-based communications data. In an alternate embodiment, the secondary device 106 can push the token to the base device 102 without any inquiry request or polling.

At 308, the processor 204 determines whether a token was recognized from the communications data. When no token is obtained, flow moves to 310, and the polling operation is repeated. When one or more token is received, flow moves to 312. At 312, the processor 204 analyzes the token to interpret the binary signal and determines whether it reads “On” or “Off”. At 314, the processor 204 determines which control attributes the token is in association with. At 316 the processor 204 dynamically updates the respective control attribute and/or functionality of the base device 102. The update may include storing a new value for the control attribute in memory of a base device 102. Optionally, the update may include changing or altering functionality of the base device without storing any new control attribute on the base device. The functionality of the base device includes, but is not limited to, any parameter to determine, set, or adjust the operation, scope, and/or content of any feature, application or scope of the base device 102. For example, the base device may include access to downloadable applications, social media, online services, games, audio and video media, a camera unit, and the like. Accordingly, functionality of the base device may include parameters to determine, set or adjust one or more of these features. For example, functionality may be binary based to prohibit or provide access to downloadable applications, or other input and output devices in association with the token. Alternatively, the functionality may be non-binary based to determine, set, or adjust the scope of content available in specific applications in association with the token.

The control attributes can include any parameter to determine, set, or adjust the operation, scope, and/or content of any feature, application or scope of the base device 102 or secondary device. As previously discussed above, the base device 102 of FIG. 1 may be a tablet, such as an iPad® device, which may include access to downloadable applications, social media, online services, games, audio and video media, a camera unit, and the like. Accordingly, control attributes for a tablet may include parameters to determine, set, or adjust one or more of these features. For example, the control attributes may be binary based to prohibit or provide access to downloadable applications, the camera unit 216, or other input and output devices 209, 210 in association with the token. Alternatively, the control attributes may be non-binary based to determine, set, or adjust the scope of content available in specific downloadable applications in association with the token. For instance, the control attributes may limit an audio or video application to only play content from a designated list of content sources or content that meets approved ratings. In another example, the control attributes may determine, set, or adjust the scope of electronic communications in association with the token. For instance, the control attributes may limit communications, such as email, social media applications, text, or instant messaging, to a designated list of contacts, a designated time of day, or a designated amount of time per day. In alternate embodiments, the base device 102 can embody other electronic devices. Accordingly, the control attributes can include any parameters to determine, set, or adjust the features of respective electronic devices.

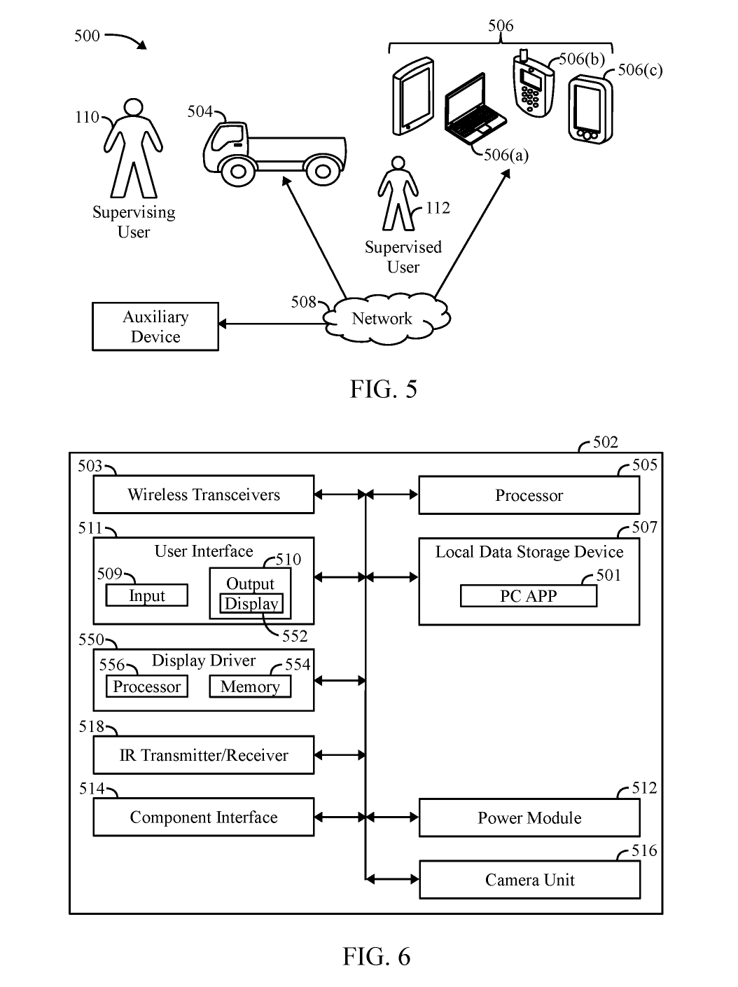

FIG. 5 illustrates a system for dynamically updating multiple control attributes, in accordance with another embodiment herein. The system 500 includes an attribute manger device 502 with a parental control (PC) application 501, a base device 504, one or more secondary devices 506, and a network 508 operatively connected to the auxiliary device 502, base device 504 and to the secondary devices 506. FIG. 5 depicts the base device 504 as an information and communication system within a vehicle, and the secondary devices 506 as a laptop computer 506a, a fitness tracking device 506b, and a mobile telephone 506c. However, non-limiting examples of the base device 504 and secondary devices 506 also include tablet computers, personal digital assistants, desktop computers, cameras, televisions, video and audio players, gaming systems, vehicle information and communication systems, and the like.

According to control attributes defined by attribute manger device 502, the base device 504 can be operated by supervising users 110, such as parents, medical professionals, employers, teachers, coaches, landlords or other authorized individuals. The base device 504 can also be operated by supervised users 112, such as children, adolescents, patients, employees, students, tenants and other unauthorized individuals who warrant supervision.

FIG. 6 illustrates a process for capturing and identifying token data in accordance with embodiments herein. In the embodiment of FIG. 6, the auxiliary device 502 includes a housing with components such as one or more wireless transceivers 503, one or more processors 505 (e.g., a microprocessor, microcomputer, application-specific integrated circuit, etc.), one or more local data storage devices 507 (also referred to as a memory portion), a user interface 511 which includes one or more input devices 509 and one or more output devices 510, a power module 512, a component interface 514, a camera unit 516, an IR transmitter/receiver 518, and a display driver 550. All of these components can be operatively coupled to one another and can be in communication with one another by way of one or more internal communication links, such as an internal bus. The components of the auxiliary device are similar to the components as depicted in FIG. 2 and described above.

The user interface 511 permits the user to operate the base device 504 for any of its intended purposes, such as administering the PC application 501, operating software applications, electronic communication, capturing images with the camera unit 516, listening to audio media, viewing video media, and the like. To that end, the input and output devices 509, 510 may each include a variety of visual, audio, and/or mechanical devices. For example, the input devices 509 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 510 can include a visual output device such as a liquid crystal display screen 552, one or more light emitting diode indicators, an audio output device such as a speaker, alarm and/or buzzer, and a mechanical output device such as a vibrating mechanism. The display 552 may be touch sensitive to various types of touch and gestures. As further examples, the output device 510 may include a touch sensitive screen, a non-touch sensitive screen, a text-only display, a smart phone display, an audio output (e.g., a speaker or headphone jack), and/or any combination thereof.

The display driver 550 is coupled to the processor 504 and configured to manage display of content on the display 552. The display driver 550 is connected to primary and secondary viewing regions of the display 552. The display driver 550 writes the desired content to the primary and secondary viewing regions under direction of the main processor 504. Optionally, the display driver 550 includes display memory 554 and one or more display control processors 556. The display memory 554 includes multiple sections to which the display control processors 556 and/or processor 504 write content to be displayed. The sections of the display memory 554 are mapped to corresponding regions of a flexible display layer. The display driver 550 provides a common display interface for all of the viewing regions within the flexible display layer within the display 552. For example, the display driver 550 manages display of content in the primary and secondary viewing regions.

The base device 504 and each secondary device 506 can communicate tokens to the auxiliary device 502. By way of example, a token may represent a binary signal indicating correspondingly whether a condition exists or an event is occurring. The PC application 501 uses the tokens to manage or update the functionality and/or control attributes. For example, supervising users 110 can designate the control attributes so that the base device 102 is operational, such as a binary on or off status, when the secondary device 506 is located inside or within a predetermined range of the vehicle. More specifically, the mobile device 506c can include a GPS or proximity sensor that indicates its position relative to the base device 504. If the mobile device 506c is located within a predetermined range of the base device 504, the mobile device 506c and/or vehicle may transmit a token indicating an “OFF” signal. In accordance with the control attributes, the PC application 501 disables one or more settings of the base device 504 or secondary device 506 to be inoperable for the supervised users 112, such as disabling texting on the mobile phone 506(c). If the mobile device 506c is outside of the predetermined range, the token indicates an “ON” signal and, in accordance with the control attributes, the PC application 501 disables one or more operational settings of the base device 504 or secondary device 506 to be operable for the supervised users 112, such as enabling texting on the mobile phone 506(c). Accordingly, the PC application 501 can manage the access, content, and function of the base device 504 or secondary devices 506 according to control attributes.

The control attributes can include any parameter to determine, set, or adjust the operation, scope, and/or content of any feature, application or scope of the base device 504 or secondary device 506. As previously discussed above, the base device 504 of FIG. 5 may be a vehicle information and communication system, which may include access to downloadable applications, social media, online services, games, audio and video media, a camera unit, and the like. Accordingly, control attributes for a vehicle may include parameters to determine, set or adjust one or more of these features. For example, the control attributes may be binary based to prohibit or provide access to downloadable applications, or other input and output devices in association with the token. Alternatively, the control attributes may be non-binary based to determine, set, or adjust the scope of content available in specific applications in association with the token.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. An electronic device comprising:
a processor;
a data storage device having executable instructions accessible by the processor;
wherein, responsive to execution of the instructions, the processor:
receives control attributes related to functionality of a base device;
detects tokens from one or more secondary devices; and
dynamically updates the functionality of the base device in association with a current one of the tokens.

2. The device of claim 1, wherein the electronic device is an auxiliary device the auxiliary device to communicate with the secondary devices to detect the tokens, the auxiliary device to communicate with the base device to direct the base device to dynamically update the control attributes.

3. The device of claim 1, wherein the electronic device is the base device.

4. The device of claim 1, wherein responsive to execution of the instructions, the processor authorizes a supervising user to input the control attribute in association with a supervised user of the base device.

5. The device of claim 1, wherein responsive to execution of the instructions, the processor monitors and manages the base device according to the control attributes.

6. The device of claim 1, wherein responsive to execution of the instructions, the processor polls the secondary device for the tokens.

7. The device of claim 1, wherein responsive to execution of the instructions, the processor determines a binary signal of the token.

8. The device of claim 1, wherein responsive to execution of the instructions, the processor determines an association between the tokens and the control attributes.

9. A non-signal readable data storage device comprising executable code to:
receive control attributes related to functionality of a base device;
detect a token from one or more secondary devices utilizing the base device; and
dynamically update the functionality of the base device in association with the token.

10. The non-signal readable data storage device of claim 9, wherein the base device houses the processor and the data storage device, the base device to communicate with the secondary devices to detect the token.

11. The non-signal readable data storage device of claim 9, further comprising executable code to monitor and manage the secondary device according to the control attributes.

12. The non-signal readable data storage device of claim 9, further comprising executable code to monitor and manage the base device according to the control attributes.

13. The non-signal readable data storage device of claim 9, further comprising executable code to determine a binary signal of the token and determine an association between the tokens and the control attributes.

14. The non-signal readable data storage device of claim 9, further comprising executable code to authorize a supervising user.

15. A method comprising:
under control of one or more processors;
receiving control attributes related to functionality of a base device;
detecting tokens from one or more secondary devices; and dynamically updating the functionality of the base device in association with the tokens.

16. The method of claim 14, further comprising polling the one or more secondary devices for the tokens.

17. The method of claim 14, further comprising authorizing a supervising user to input the control attribute in association with a supervised user.

18. The method of claim 14, further comprising:
utilizing an auxiliary device for communicating with the secondary devices to detect the tokens and for communicating with the base device to dynamically update the control attributes.

19. The method of claim 14, further comprising monitoring and managing the base device according to the control attributes.

20. The method of claim 14, further comprising determining an association between the tokens and at least one of the control attributes.
